(19) United States
(12) Patent Application Publication
(10) Pub. No.: US 2015/0032784 A1
(43) Pub. Date: Jan. 29, 2015

(54) ELECTRONIC DEVICE AND METHOD FOR PROCESSING SYSTEM EVENT LOGS

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: DAN-LI HU, Shenzhen (CN); BO YU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/972,903

(22) Filed: Aug. 21, 2013

(30) Foreign Application Priority Data
Jul. 26, 2013 (CN) 2013103202227

(51) Int. Cl. G06F 17/30

(52) U.S. Cl. CPC G06F 17/30194
USPC 707/827

(57) ABSTRACT

A method of processing system event logs (SELs) of a second electronic device using a first electronic device. The SELs are stored in a second storage device of the second electronic device. Once a baseboard management controller (BMC) of the second electronic device sends warning signal, which indicates that a remaining space of the second storage device, is less than a predetermined value, the first electronic device obtains the SELs in the second storage device, and stores the obtained SELs in a first storage device of the first electronic device. The first electronic device further controls the BMC to delete the SELs in the second storage device, to release space of the second storage device.

### BACKGROUND

1. Technical Field

Embodiments of the present disclosure relates to data management technology, and more particularly to an electronic device and a method for processing system event logs (SELs) of a target electronic device.

2. Description of related art

A baseboard management controller (BMC) acts as a monitoring unit of an electronic device (e.g., a server or a computer). The BMC monitors events of the electronic device and generates the SELs to record the events. The SELs are stored in a storage device of the electronic device by the BMC. However, if the electronic device runs for a long time, more events may occur, and the storage device may be full of the SELs and cannot store newly generated SELs, as storage space of the storage device is limited. Therefore, there is room for improvement in the art.

### BRIEF DESCRIPTION OF THE DRAWINGS

FIG. 1 is a block diagram of one embodiment of a first electronic device including a processing system, in communication with a second electronic device, which includes a baseboard management controller (BMC).

FIG. 2 is a block diagram of function modules of the processing system included in the first electronic device of FIG. 1.

FIG. 3 is a flowchart of a first embodiment of a processing method to process system event logs (SELs) of the second electronic device of FIG. 1.

FIG. 4 is a flowchart of a second embodiment of the processing method to process the SELs of the second electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

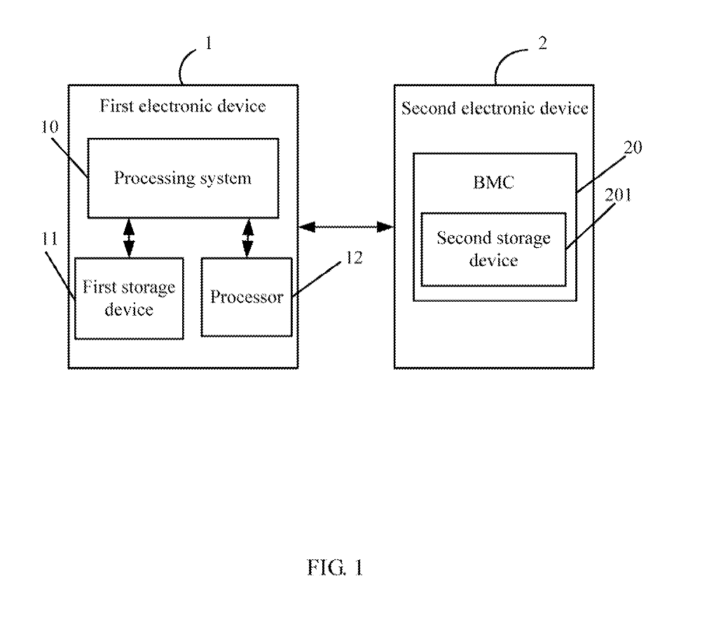

FIG. 1 is a block diagram of one embodiment of a first electronic device 1 in communication with a second electronic device 2. In this embodiment, the first electronic device 1 and the second electronic device 2 are computers or servers or a combination. Depending on the embodiments, the second electronic device 2 is regarded as a target device for the first electronic device 1.

The first electronic device 1 includes a processing system 10, a first storage device 11 and at least one processor 12. The second electronic device 2 includes a baseboard management controller (BMC) 20, which includes a second storage device 201. The first electronic device 1 and the second electronic device 2 may include more or fewer components than illustrated, or have a different configuration of the various components in other embodiments.

The BMC 20 monitors events of the second electronic device 2. The event may represent a temperature value or other system parameters (e.g., a speed value of a fan) of the second electronic device 2 that exceed a preset threshold value. When the BMC 20 monitors that more than one event occurs, the BMC 20 generates a system event log (SEL) to record an occurrence time of the event. The BMC 20 further stores the SEL in the second storage device 201.

For example, if the BMC 20 finds that the temperature value (e.g., 45C) of the second electronic device 2, exceeds the preset threshold value (e.g., 40C) at Dec. 28, 2012 12:30 pm, the BMC 20 generates a SEL to record the temperature value (45C) of the second electronic device 2, exceeds the preset threshold value (40C) at 2012/12/28, 12:30 pm time, and stores the SEL in the second storage device 201.

In this embodiment, the BMC 20 further monitors a remaining space of the second storage device 201. Once the remaining space of the second storage device 201 is less than a predetermined value, the BMC 20 sends a warning signal to the first electronic device 1. When the first electronic device 1 receives the warning signal, the processing system 10 obtains the SELs that are stored in the second storage device 201, and stores the obtained SELs in a first storage device 11 of the first electronic device 1. Details will be given in the following paragraphs.

In this embodiment, the second storage device 201 is an Electrically Erasable

Programmable Read-Only Memory (EEPROM). The first storage device 11 is a hard disk of the first electronic device 1. The first electronic device 1 further includes at least one processor 12.

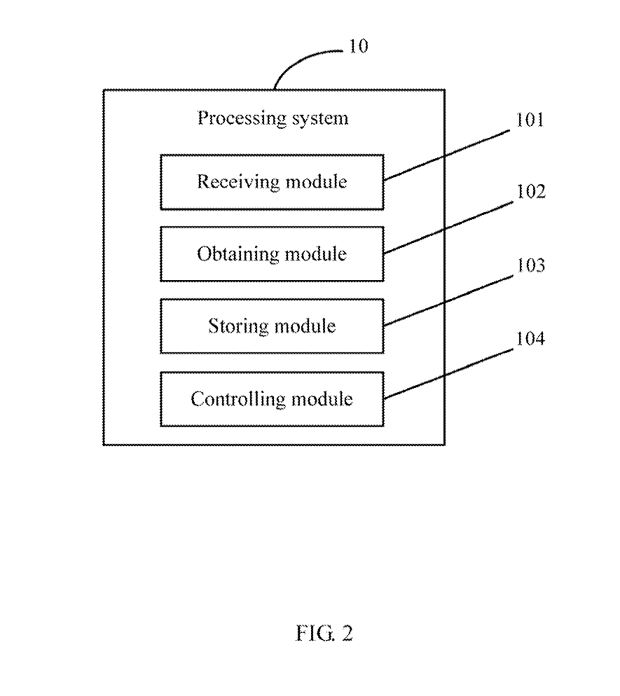

FIG. 2 is a block diagram of function modules of the processing system 10 included in the first electronic device 1 of FIG. 1. In this embodiment, the processing system 10 may include a receiving module 101, an obtaining module 102, a storing module 103, and a controlling module 104. The modules 101-104 comprise computerized codes in the form of one or more programs that may be stored in the first storage device 11. The computerized code includes instructions that are executed by the at least one processor 12.

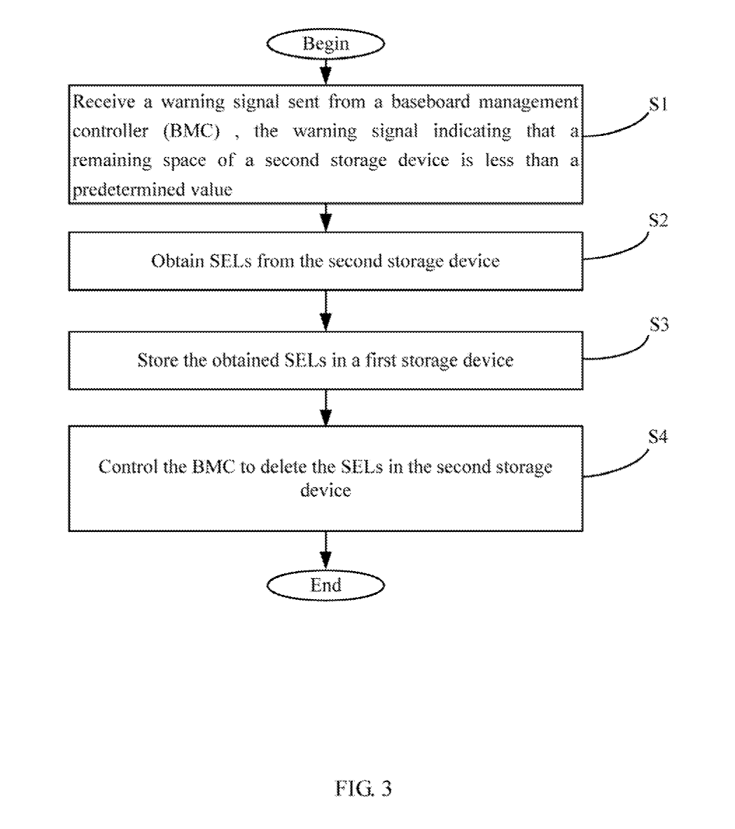

FIG. 3 is a flowchart of a first embodiment of a method of processing the SELs of the second electronic device 2 of FIG. 1. Depending on the embodiment, additional steps may be added, others deleted, and the ordering of the steps may be changed.

In step S1, the receiving module 101 receives the warning signal sent from the BMC 20, the warning signal indicating that the remaining space of the second storage device 201 is less than the predetermined value.

As mentioned above, the BMC 20 monitors the events of the second electronic device 2, and generates the SELs to record the events. The SELs are stored in the second storage device 201 by the BMC 20. The BMC 20 further monitors the remaining space of the second storage device 201, and sends the warning signal to the first electronic device 1, when the remaining space of the second storage device 201 is less than the predetermined value.

For example, if a memory space of the second storage device 201 is 500 MB (megabytes), and the predetermined value is 100 MB, when the BMC 20 finds that the remaining space of the second storage device 201 is less than 100 MB, the BMC 20 sends the warming signal to the first electronic device 1.

In step S2, the obtaining module 102 obtains the SELs from the second storage device 201. In this embodiment, the obtaining module 102 obtains the SELs by sending a first predetermined Intelligent Platform Management Interface (IPMI) command to the BMC 20. The first IPMI command controls the BMC 20 to return the SELs of the second storage device 201. That is, the obtaining module 102 obtains the SELs when the first electronic device 11 receives the returned SELS.

In step S3, the storing module 103 stores the obtained SELs in the first storage device 11. In this embodiment, the storing module 103 stores the obtained SELs in the first storage device 11, according to the occurrence time of the events.

In step S4, the controlling module 104 controls the BMC 20 to delete the SELs in the second storage device 201. In this embodiment, the controlling module 104 sends a second predetermined IPMI command to the BMC 20, the second predetermined IPMI command controls the BMC 20 to delete the SELs in the second storage device 201. When the BMC 20 receives the second predetermined IPMI command, the BMC 20 deletes the SELs in the second storage device 201, to release space of the second storage device 201 to store newly generated SELs by the BMC 20.

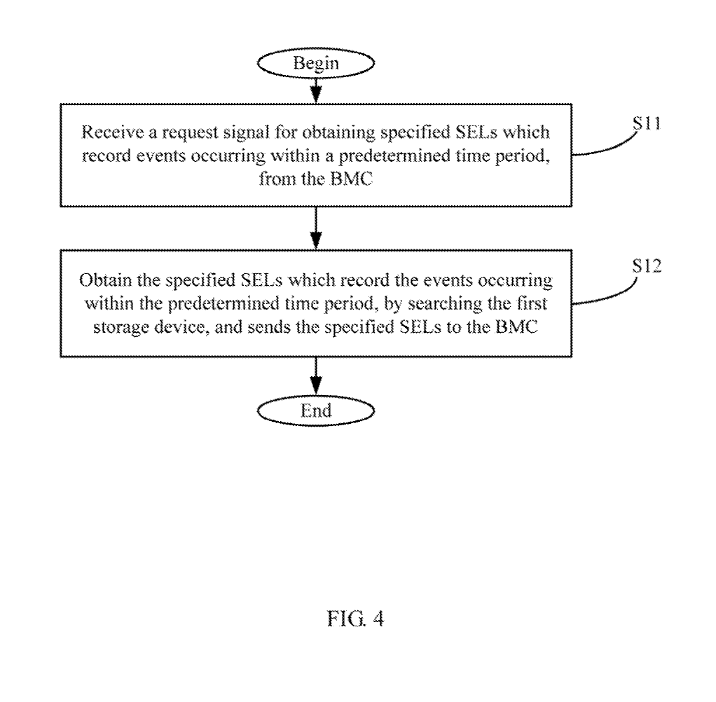

FIG. 4 is a flowchart of a second embodiment of a method of processing the SELs of the second electronic device 2 of FIG. 1. Depending on the embodiment, additional steps may be added, others deleted, and the ordering of the steps may be changed.

In step S11, the receiving module 101 receives a request signal to obtain specified SELs which record events occurred within a predetermined time period, from the BMC 20.

For example, the SELs record events occurring between Jan. 1, 2012 and Dec. 31,2012 and are stored in the first storage device 11. If the BMC 20 needs to obtain event logs occurring between Dec. 1, 2012 and Dec. 31, 2012 the BMC 20 sends the request signal to obtain the SELs occurred between Dec. 1, 2012 and Dec. 31, 2012 to the first electronic device 1. Then, the receiving module 101 receives the request signal.

In step S12, the obtaining module 102 obtains the specified SELs which record the events occurred within the predetermined time period, by searching the first storage device 11. When the obtaining module 102 obtains the specified SELs from the first storage device 11, the obtaining module 102 sends the specified SELs to the BMC 20.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. A method for processing system event logs (SELs) of a second electronic device using a first electronic device, the SELs stored in a second storage device of the second electronic device, the first electronic device comprising a first storage device, and at least one processor, the method comprising:
receiving a warning signal sent from a baseboard management controller (BMC) of the second electronic device, the warning signal indicating that a remaining space of the second storage device is less than a predetermined value;
obtaining the SELs from the second storage device;
storing the obtained SELs in the first storage device; and
controlling the BMC to delete the SELs in the second storage device.

2. The method of claim 1, further comprising:
receiving a request signal for obtaining specified SELs which record events occurring within a predetermined time period, from the BMC; and
obtaining the specified SELs which record the events occurring within the predetermined time period, by searching the first storage device, and sending the specified SELs to the BMC.

3. The method of claim 1, wherein the obtained SELs are stored in the first storage device according to an occurrence time of events.

4. An electronic device in communication with a target electronic device, the electronic device comprising:
at least one processor; and
a first storage device storing a plurality of instructions, which when executed by the processor, causes the processor to:
receive a warning signal sent from a baseboard management controller (BMC) of the target electronic device, the warning signal indicating that a remaining space of a second storage device of the target electronic device is less than a predetermined value, the second storage device storing system event logs (SELs) of the target electronic device;
obtain the SELs from the second storage device;
store the obtained SELs in the first storage device; and
control the BMC to delete the SELs in the second storage device.

5. The first electronic device of claim 4, wherein the processor further:
receive a request signal for obtaining specified SELs which record events occurring within a predetermined time period, from the BMC; and
obtain the specified SELs which record the events occurring within the predetermined time period, by searching the first storage device, and sending the specified SELs to the BMC.

6. The first electronic device of claim 4, wherein the obtained SELs are stored in the first storage device according to an occurrence time of events.

7. A non-transitory storage medium having stored thereon instructions that, when executed by a processor of an electronic device, causes the electronic device to perform a method for processing system event logs (SELs) of a target electronic device, the electronic device comprising a first storage device, the method comprising:
receiving a warning signal sent from a baseboard management controller (BMC) of the target electronic device, the warning signal indicating that a remaining space of a second storage device, of the target electronic device is less than a predetermined value, the second storage device storing system event logs (SELs) of the target electronic device;
obtaining the SELs from the second storage device;
storing the obtained SELs in the first storage device; and
controlling the BMC to delete the SELs in the second storage device.

8. The non-transitory storage medium of claim 7, further comprising:
receiving a request signal for obtaining specified SELs which record events occurring within a predetermined time period, from the BMC; and
obtaining the specified SELs which record the events occurring within the predetermined time period, by searching the first storage device, and sending the specified SELs to the BMC.

9. The non-transitory storage medium of claim 7, wherein the obtained SELs are stored in the first storage device according to an occurrence time of events.
